(19) United States
(12) Patent Application Publication
(10) Pub. No.: US 2013/0024030 A1
(43) Pub. Date: Jan. 24, 2013

(54) Method of Using a Downhole Smart Control System

(71) Applicants: Paulo Tubel, The Woodlands, TX (US); Rogelio Cantu, The Woodlands, TX (US); Jorge Laurent, The Woodlands, TX (US); James Kendall Warren, Conroe, TX (US); Sagar Shinde, Houston, TX (US); Amanda Tubel, The Woodlands, TX (US)

(72) Inventors: Paulo Tubel, The Woodlands, TX (US); Rogelio Cantu, The Woodlands, TX (US); Jorge Laurent, The Woodlands, TX (US); James Kendall Warren, Conroe, TX (US); Sagar Shinde, Houston, TX (US); Amanda Tubel, The Woodlands, TX (US)

(21) Appl. No.: 13/186,802

(22) Filed: Jul. 20, 2011

(51) Int. Cl. G05D 7/06

(52) U.S. Cl. 700/282

(57) ABSTRACT

A method of using a wellbore insert for downhole operations such as frac operations, e.g. where the frac work starts where the surface fluid is pumped through one or more addressable wellbore inserts via their ports into the formation pursuant to a first set of control signals which may be transmitted from a surface location. Once the operation, e.g. a frac operation, is completed, a second set of signals may be generated to effect a different wellbore function. The wellbore insert typically comprises a housing having an inner annulus and one or more ports dimensioned and configured to provide a fluid pathway between the inner annulus of the housing and the outer surface of the housing. A selectively movable port seal, operable via a port seal mover, is dimensioned and configured to selectively occlude or open these ports. A movable plug, controlled by a plug mover, operates within the housing to selectively permit or occlude fluid flow within the housing. A power supply and a detector are typically present within the housing. An individually addressable electronic control module is operable to effect a change in the position of the selectively movable port seal and/or the movable plug.

### BACKGROUND

There is a significant activity in the oilfield today to perform operations such as frac work in shales or deepwater to provide a path for hydrocarbons stored in the formations to be produced. Horizontal wells are drilled and divided into multiple zones within the horizontal and deviated sections of the well. Each zone is fraced individually to allow for the production of hydrocarbon. Each zone may further comprise a packer used to isolate and create multiple zones downhole and a sliding sleeve.

Normally, a sliding sleeve controls the flow of fluid from the inside of the production pipe into the reservoir or from the reservoir to the inside of the production pipe. For frac applications, the sleeve is adapted with a seat which is attached to the inner sleeve. The seat allows for a ball pumped from the surface into the well to be seated on the seat, sealing the well below the ball. The seats may have multiple diameters allowing for multiple diameter balls to be deployed in a well. A large seat will allow a smaller ball to pass by the seat and reach a seat at a lower zone in the well.

Once the well is frac'ed the seats and the balls in the well are milled out to allow production to occur. The costs associated with pumping balls in wells and the cost and time associated with milling the balls and seats are quite high. Also, there is a limit to the number of balls and seats that can be used due to the size of the balls and the potential that a small ball may not go through a seat. This limitation reduces the options related to the number of sliding sleeves that can be deployed in a well hence limiting the number of production zones that can be created in a well.

In addition, there cannot be any control of the hydrocarbon flow in the laterals because no hydraulic lines or electrical lines can be deployed from the main bore into the laterals so that all control of each lateral has to be done from far away in the main bore.

### FIGURES

The figures supplied herein disclose various embodiments of the claimed invention.

FIG. 1 is a plan view in partial perspective of a first embodiment of the downhole smart control system.

FIG. 2 is a cutaway view in partial perspective of the first embodiment of the downhole smart control system.

FIG. 3 is a cutaway view in partial perspective of a second embodiment of the downhole smart control system.

FIG. 4 is a cutaway view of an exemplary deployment of the downhole smart control system.

### DESCRIPTION OF EMBODIMENTS OF THE INVENTION

An electromechanical downhole smart control system such as that described below may be used to replace a ball and seat in a sliding sleeve in a wellbore to control the a wellbore process such as a frac process at individual hydrocarbon production zones.

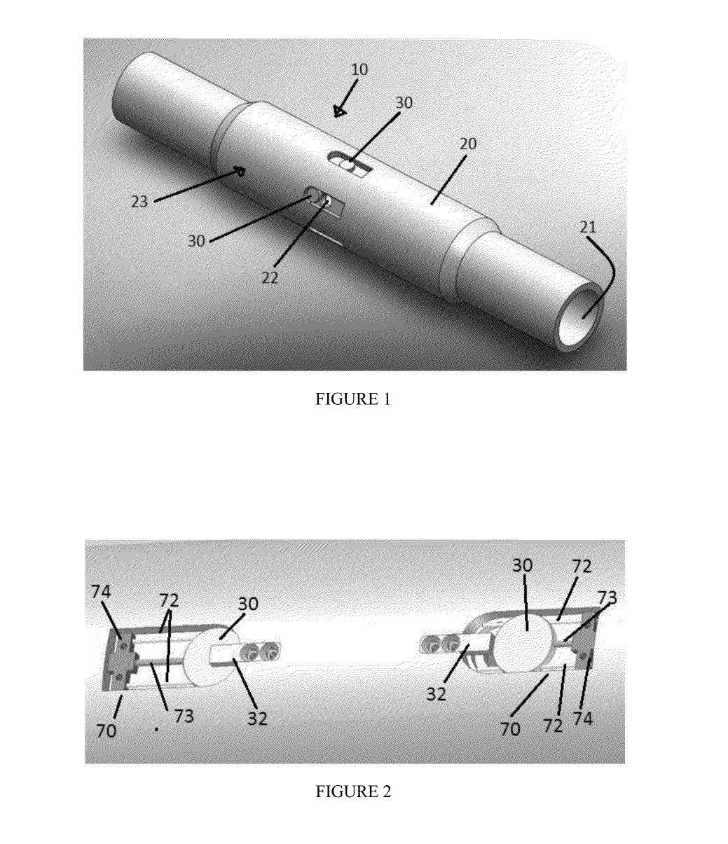

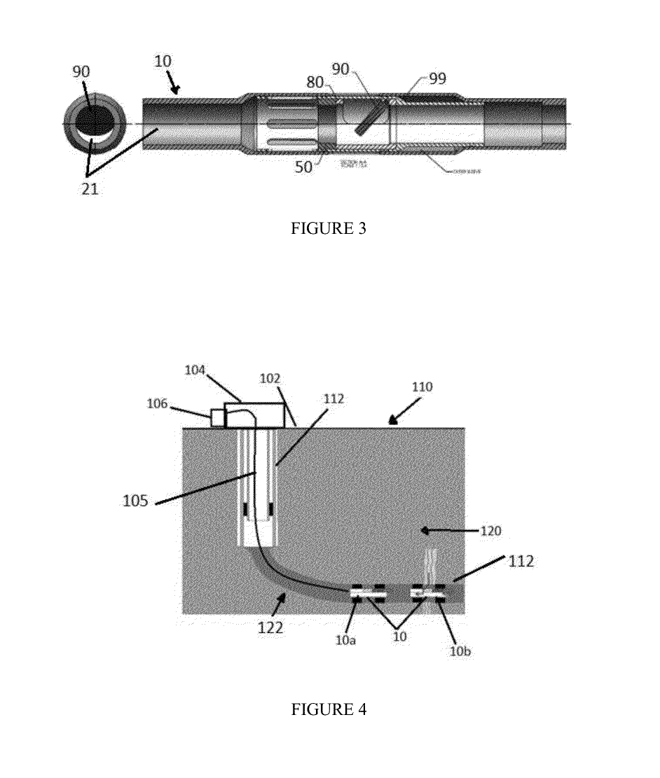

Referring now to FIG. 1, in a first embodiment, wellbore insert 10 comprises housing 20, one or more selectively movable port seals 30 disposed about housing 20 proximate port 22; electronic control module 40 (FIG. 3) disposed proximate selectively movable port seal 30; power supply 50 (FIG. 3) disposed proximate electronic control module 40 and operatively in communication with electronic control module 40; detector 60 (FIG. 3) disposed proximate housing 20 and operatively in communication with electronic control module 40; and seal mover 70 (FIG. 2) disposed proximate selectively movable port seal 30, where seal mover 70 is operatively in communication with electronic control module 40, power supply 50, and selectively movable port seal 30.

Wellbore insert 10 is dimensioned and configured to be deployed through wellbore tube 112 (FIG. 4) to control sections of well 110 (FIG. 4), e.g. ones that in the past have been producing hydrocarbons.

In typical embodiments housing 20 further comprises inner annulus 21 and port 22. Port 22 is dimensioned and configured to provide a fluid pathway between inner annulus 21 and outer surface 23 of housing 20.

Selectively movable port seal 30 is typically disposed on outer surface 23, at least partially within housing 20, on an inner surface 24 (FIG. 3) of housing 20, or the like, or a combination thereof. Selectively movable port seal 30 typically is a seal plug dimensioned and configured to selectively occlude or open port 22, e.g. from fluid flows between inner annulus 21 and areas outside outer surface 23 such as wellbore 112 (FIG. 4), which can comprise a tube or pipe or the like.

Referring additionally to FIG. 2, in one embodiment, selectively movable port seal 30 is slidably secured by seal retainer 32 which may further comprise one or more rails 72. In these embodiments, selectively movable port seal 30 is slidably mounted to rails 72.

In one embodiment, seal mover 70 comprises screw 73 and motor 74 which is operatively in communication with screw 73 and electronic control module 50 (FIG. 3). Turning screw 73 moves selectively movable port seal 30 along rails 72 between a first position which allows fluid flow in port 22 and second position which occludes fluid flow in port 22. In a further embodiment, movement of selectively movable port seal 30 along rails 72 may be via use of solenoid 76 (not shown in the figures but configured similarly to motor 74) which is operatively in communication with screw 73 and electronic control module 50. As will be familiar to those of ordinary skill in these arts, solenoid 76 may be dimensioned and configured to move selectively movable port seal 30 between a first position which allows fluid flow in port 22 and a second position which occludes fluid flow in port 22.

Referring now additionally to FIG. 3, in a further embodiment, wellbore insert 10 further comprises one or more selectively movable plugs 90 (FIG. 3) disposed within inner annulus 21 where movable plug 90 is operatively in communication with electronic control module 40 (FIG. 3) and dimensioned and adapted to selectively occlude or open inner annulus 21. Movable plug mover 92 is operatively connected to movable plug 90. Movable plug mover 92, in typical embodiments, further comprises releasable spring 93 disposed proximate movable plug 90 and operatively in communication with movable plug 93 as well as spring release 94 disposed proximate spring 93 and operatively in communication with releasable spring 93. In certain of these embodiments, releasing spring 93 is operative to release movable plug 90.

In other contemplated embodiments, movable plug mover 92 may be a mechanical mover, e.g. one comprising a piston.

Detector 80 is disposed at least partially within housing 20. Detector 80 typically comprises a sensor such as a pressure sensor, a temperature sensor, a resistivity sensor, an inductive sensor, a gamma ray sensor, a strain gauge, an accelerometer, or a radio frequency identification module, or the like, or a combination thereof. Additional sensors downhole may be deployed permanently, such as a resistivity module and gamma ray to monitor formation fluid in the well and radioactive tags deployed during a well operation such as a frac operation.

Electronic control module 40 (FIG. 3) is operatively in communication with detector 80 (FIG. 3), seal mover 70 (FIG. 2), and movable plug mover 92 (FIG. 3), and is dimensioned and configured to effect a change in either selectively movable port seal 30, movable plug 70, or both of them. Electronic control module 40 most typically comprises a microprocessor (not shown in the figures) as well as memory, both RAM and ROM, to effect the functions of electronic control module 40. Although it can be disposed in numerous places, typically electronic control module 40 is disposed totally within housing 20. In some embodiments, electronic control module 40 is responsive to input received at electronic control module 40 from detector 80 (FIG. 3) and will change the position of selectively movable port seal 30 based at least in part on data received from detector 80.

Electronic control module 40 further typically comprises a communications module (not shown in the figures) dimensioned and adapted to allow for communications from surface 102 (FIG. 4) into well 110 (FIG. 4) and from well 110 back to surface 102. The communications may comprise signals used to trigger opening and closing movable port seals 30 and/or movable plug 70 (FIG. 3) as well as to choke the flow of fluid and gas from formation 120 (FIG. 4) to the inside of wellbore insert 10. Where a plurality of movable port seals 30 exists, each may further be separately, individually controlled by an associated seal mover 70 from a corresponding plurality of seal movers 70.

In most embodiments, electronic control module 40 (FIG. 3) is selectively addressable, i.e. it has a specific and unique address as will be familiar to those of ordinary skill in the data communications arts. This address may be user selectable and/or pre-programmed into electronic control module 40. In these embodiments, changes in the position of selectively movable port seal 30 (FIG. 2) and/or movable plug 70 (FIG. 3) may be made in response to a communicated signal comprising the address of electronic control module 40.

Power supply 50 (FIG. 3) may comprises battery pack 51 (FIG. 3), power conditioning system (52), or the like, or a combination thereof. Power supply 50 is typically disposed totally within housing 20. In certain embodiments, power supply 50 may draw its power from cable 105 (FIG. 5).

In a further embodiment, referring to FIGS. 3 and 4, a system comprising wellbore insert 10 comprises one or more packers disposed above and/or below the flow control used for isolation of the inside of the tube.

Referring generally to FIG. 4, in various embodiments, the claimed systems can be used for controlling wells 110, e.g. older wells, where originally no well control systems were installed. Systems using the claimed wellbore inserts 10 can be installed through tubing 112, e.g., and can utilize tools such as packers for the isolation of the inner production pipe above and below the wellbore inserts 10. The system can utilize various power supplies such as batteries 23 for power inside well 110 for control and communications. Acoustic, pressure pulses and electromagnetic waves can be used for communications in and out of well 110 for data and command transfer from downhole to surface 102 and surface 102 to downhole.

In embodiments, one or more wellbore inserts 10 can be deployed in deepwater applications where the full inner bore of tubing 112 is required for production of hydrocarbons or fluid injection in wells 102. In these embodiments, wellbore insert 10 may be larger than otherwise used for non-deepwater applications. In these embodiments, one or more movable port seals 30 may be removed from wellbore insert 10 for use in a deepwater well to allow control of the flow of hydrocarbons where a full bore inside diameter capability of the production pipe is required and where no moving modules inside the pipe is acceptable for higher reliability.

Wellbore inserts 10 can be deployed anywhere in well 102 but are preferably deployed in the laterals of wells 102. The ability to have short hop power and communications in conjunction with wellbore inserts 10 aids in allowing for full control and monitoring of the laterals for increase production of hydrocarbons.

In the operation of a preferred embodiment, one or more ports 22 (FIG. 1) are drilled in housing 20 (FIG. 1) and movable port seal 30 (FIG. 2) is operatively attached to motor 74 (FIG. 2) disposed about housing 20. Movement of an operative part of motor 74 causes movable port seal 30 to move, e.g. slide along rails 72 (FIG. 2), and selectively open or close port 22. In a preferred embodiment, when movable port seal 30 closes port 22 it seals port 22 as well.

In further embodiments, movable plug 90 (FIG. 3) is also present. Movable plug 90 may be selectively moved from a first to a second position inside housing 20 to selectively open or close inner annulus 21 (FIG. 3) to fluid flow such as might be needed for, e.g., frac work. Movable plug 90 seals well 102 (FIG. 4). Movable port seal 30 (FIG. 2), attached to motor 74 (FIG. 2), may then open, allowing the frac fluid to go from inner annulus 21 into formation 120 (FIG. 4). This allows deployment of wellbore insert 10 (FIG. 1) through tubing 112 (FIG. 4) to control fluid flow such as from the existing perforated zones that were producing without control. Using wellbore insert 10 can allow, e.g., shutting off any zone that produces water.

The same flow control can be used in deepwater for deployment in laterals 122 (FIG. 5). However, in a currently contemplated embodiment wellbore insert 10 for such environments will be larger than a non-deepwater, through tubing one.

In a preferred embodiment, movable plug 90 (FIG. 3) moves from a first position within annulus 21 (FIG. 3), and plugs pipe 112 (FIG. 4) by moving to a second position within annulus 21 to impede fluid flow within pipe 112. Once movable plug 90 is released and plugs inner annulus 21, high pressure is created on movable plug 90 using fluid introduced from upstream location 104 (FIG. 4), e.g. a pump located at surface 102 (FIG. 4). This high pressure fluid is detected by one or more detectors 80 (FIG. 3) which provide information to electronic control module 40 (FIG. 3) and electronic control module 40 may use that information in deciding whether or not to open movable port seal 30 (FIG. 2). Opening movable port seal 30 typically allows fluid flow between inner annulus 21 and formation 120 (FIG. 4).

Electronic control module 40 (FIG. 3), which typically comprises a microprocessor and associated memory, will monitor data acquired downhole such as pressure data and may further await a command signal which may comprise pattern of high and low pulses such as pressure pulses created at surface 102 by control system 106 (FIG. 4). Once electronic control module 40 detects and verifies the proper pattern it will cause operation of movable plug mover 92 (FIG. 3) (e.g., a motor or solenoid) to release releasable spring 93 (FIG. 3), thereby releasing movable plug 90 (FIG. 3). Movable plug 90 moves from its first position to its second position, thereby plugging pipe 112 by closing inner annulus 21 (FIG. 3) to further fluid flow.

Once wellbore pipe 112 is plugged, high pressure is placed on movable plug 90 (FIG. 3) such as by introducing a fluid under pressure from an upstream position, e.g. surface 102. Once the high pressure is detected downhole, electronic control module 40 (FIG. 3) instructs seal mover 70 (FIG. 2) to move one or more selectively movable port seals 30 (FIG. 2) in housing 20 (FIG. 2).

Wellbore insert 10 (FIG. 3) can be used for frac operations, through tubing zone production operations, intelligent well applications, and the like, or combinations thereof. By way of example and not limitation, for frac operations, the frac work starts where surface fluid is pumped through wellbore insert 10 (FIG. 4) deployed downhole into formation 120 (FIG. 4). Typical configurations will have multiple wellbore inserts 10, e.g. wellbore inserts 10a and 10b, deployed in sequence in wellbore 112 (FIG. 4) at offsets from one another within wellbore 112. For these configurations, once the frac is completed, a second set of pressure sequences is generated from surface 102 (FIG. 4) to move a further wellbore insert 10, e.g. an adjacent one such as 10b, in a further part of wellbore 112. This second pressure sequence may differ in its high and low pulse sequences from the prior pressure sequence.

Upon the completion of all frac operations, a control system as control system 106 (FIG. 4) sends a command signal which may comprise a third pressure pulse sequence. Upon detection and verification of this command signal, electronic control module 40 of a predetermined movable insert 10, e.g. 10a (FIG. 4) which is closest to surface 102, instructs movable plug mover 92 (FIG. 3) to move movable plug 90 (FIG. 3) back to its first position, e.g. its open position within inner annulus 21 (FIG. 3), to allow for fluid production.

In certain embodiments, when movable plug 90 (FIG. 3) is released, upstream fluid, e.g. fluid from surface 102 (FIG. 4), is allowed to flow in wellbore 112 to the next wellbore insert 10 in well 102 (FIG. 4), e.g. from wellbore insert 10a (FIG. 4) to wellbore insert 10b (FIG. 4). In certain embodiments, detection of higher pressure or pressure pulses trigger electronic control module 40 (FIG. 3) to release spring 93 (FIG. 3) to move movable plug 90 within wellbore insert 10.

This sequencing can be repeated until all moveable plugs 90 (FIG. 3) within wellbore inserts 10 (FIG. 3) deployed in wellbore 112 have been released and the entire length of wellbore pipe 112 is free to allow fluids such as hydrocarbons to flow within wellbore pipe 112.

The foregoing disclosure and description of the inventions are illustrative and explanatory. Various changes in the size, shape, and materials, as well as in the details of the illustrative construction and/or a illustrative method may be made without departing from the spirit of the invention

What is claimed is:

1. A method of controlling a wellbore insert deployed in a wellbore, the method comprising:
a. deploying a wellbore insert within a wellbore pipe, the wellbore insert further comprising:
i. a housing, the housing further comprising:
1. an inner annulus; and
2. a port dimensioned and configured to provide a fluid pathway between the inner annulus of the housing and an outer surface of the housing;
ii. a selectively movable port seal disposed about the housing proximate the port and dimensioned and configured to selectively occlude or open the port;
iii. a seal mover disposed proximate the selectively movable port seal and operatively in communication with the selectively movable port seal;
iv. a selectively movable plug disposed within the inner annulus, the movable plug dimensioned and adapted to selectively occlude or open the inner annulus;
v. a plug mover disposed proximate the selectively movable plug, the plug mover operatively connected to the movable plug;
vi. an individually addressable electronic control module disposed proximate the selectively movable port seal and operatively in communication with the seal mover and the plug mover;
vii. a power supply disposed proximate the electronic control module and operatively in communication with at least one of the electronic control module, the seal mover, and the plug mover; and
viii. a detector disposed proximate the electronic control module and operatively in communication with the electronic control module;
b. acquiring a predetermined set of data by the detector while the wellbore insert is deployed within the wellbore pipe;
c. communicating the predetermined set of data to the electronic control module at a predetermined time interval;
d. creating a first predetermined signal pattern detectable by the electronic control module;
e. communicating the first signal pattern to the electronic control module to effect a command or data transfer through at least one of a wireless transmission, transmission using the pipe, or transmission using fluid present in the well; and
f. effecting a change in a current position of at least one of the selectively movable port seal or the movable plug based on receipt of the first signal pattern, thus selectively impeding or allowing a flow of fluid within the housing.

2. The method of claim 1, further comprising using a cable disposed within the well for at least one of supplying power to or enabling communications with the electronic control module.

3. The method of claim 1, further comprising verifying the communicated signal pattern by the electronic control module as a signal pattern designated for that electronic control module, wherein the effecting step takes place upon verification.

4. The method of claim 3, wherein controlling the selectively movable plug further comprises:
a. upon verification, using the electronic control module to cause the release of a spring controlled plug disposed at least partially within the housing, the spring controlled plug operatively in communication with the selectively movable plug;
b. releasing the selectively movable plug by movement of the spring controlled plug; and
c. allowing the released selectively movable plug to move from a first predetermined position to a second predetermined position within the wellbore pipe to operatively plug the wellbore pipe.

5. The method of claim 1, wherein the communication of the predetermined signal pattern comprises use of at least one of acoustic energy, an electromagnetic wave, or a fluid pressure pulse.

6. The method of claim 5, wherein the fluid pressure pulse comprises a series of high and low pressure pulses generated at a surface location by a control system, the predetermined signal pattern detectable by the electronic control module.

7. The method of claim 1, further comprising:
a. waiting for a predetermined wellbore operation to complete;
b. creating a second predetermined signal pattern detectable by the electronic control module after the predetermined wellbore operation completes; and
c. communicating the second signal pattern to the electronic control module to effect a command or data transfer through at least one of a wireless transmission, transmission using the pipe, or transmission using fluid present in the well.

8. The method of claim 7, further comprising:
a. generating a third predetermined signal pattern;
b. communicating the third predetermined signal pattern downhole using at least one of a wireless transmission, transmission using the pipe, or transmission using fluid present in the well;
c. detecting the third predetermined signal pattern at the wellbore insert by the electronic control module; and
d. causing the selectively movable plug to move to its first predetermined position to allow for production of fluids within the wellbore pipe.

9. The method of claim 8, wherein, as the selectively movable plug is released, the selectively movable plug permits fluid in the wellbore to flow from the surface to a further wellbore insert in the well.

10. The method of claim 9, further comprising repeating the release of the selectively movable plug until all selectively movable plugs present in the wellbore have been released and the entire length of the wellbore pipe is free to produce a desired fluid.

11. The method of claim 1, further comprising permanently deploying the detector in the wellbore.

12. The method of claim 1, wherein the detector comprises a sensor, the method further comprising acquiring at least one of pressure or temperature data by the detector while the wellbore insert is deployed downhole within a wellbore.

13. The method of claim 12, wherein the acquisition occurs during at least one of a frac operation or fluid production after the frac operation.

14. The method of claim 1, wherein the detector comprises at least one of a resistivity or inductive sensor, the method further comprising acquiring data by the detector sufficient to monitor a fluid type of fluid flowing within the wellbore.

15. The method of claim 14, wherein the acquisition occurs during at least one of a frac operation or fluid production after the frac operation.

16. The method of claim 1, further comprising allowing a predetermined fluid to flow from the inner annulus into a surrounding formation by injecting the predetermined fluid from the surface through the wellbore tube.

17. The method of claim 1, further comprising removing the selectively movable port seal from a wellbore insert for use in a deepwater well for control of the flow of hydrocarbons where a full bore inside diameter capability of the production pipe is required and where no moving modules inside the pipe is acceptable for higher reliability.

18. The method of claim 1, wherein the selectively movable port seal comprises a plurality of selectively movable port seals and the seal mover comprises a plurality of individually controllable seal movers, each selectively movable port seal being operatively in communication with a separate, individually controllable seal mover, the method further comprising effecting a change in a current position of a specific selectively movable port seal based on receipt of the first signal pattern, thus selectively impeding or allowing a flow of fluid within the housing.

19. The method of claim 1, further comprising:
a. providing each electronic control module with an individual address; and
b. deploying a plurality of wellbore inserts in the wellbore pipe, each comprising at least one individually addressed electronic control module.

20. The method of claim 19, further comprising deploying the plurality of wellbore inserts in a plurality of locations within the wellbore, the plurality of locations comprising a wellbore lateral wellbore.
